(19) United States
(12) Patent Application Publication
(10) Pub. No.: US 2026/0071633 A1
(43) Pub. Date: Mar. 12, 2026

(54) PORTED COMPRESSOR WITH PARTIALLY SWEPT LEADING EDGE FOR GAS TURBINE ENGINE

(71) Applicant: HONEYWELL INTERNATIONAL INC., Charlotte, NC (US)

(72) Inventors: Jyotichandra Jingade, Bangalore (IN); Shailesh Kumar, Bangalore (IN); Shakeel Nasir, Phoenix, AZ (US); Jeffrey Guymon, Phoenix, AZ (US); John Schugardt, Phoenix, AZ (US)

(73) Assignee: HONEYWELL INTERNATIONAL INC., Charlotte, NC (US)

(21) Appl. No.: 18/944,245

(22) Filed: Nov. 12, 2024

(30) Foreign Application Priority Data
Sep. 6, 2024 (IN) 202411067577

(51) Int. Cl. F04D 29/28; F04D 17/12

(52) U.S. Cl. CPC F04D 29/286; F04D 17/12

(57) ABSTRACT

A compressor section for a gas turbine engine includes an inlet duct, a port plenum, and an impeller. The port plenum has a port inlet and a port outlet. The port inlet is in fluid communication with the inlet duct. The impeller includes a hub, a shroud, and an impeller blade. The impeller blade extends for a span that is 0% at the hub and 100% at a tip. The impeller blade has a partially swept leading edge and extends in a streamwise direction from the partially swept leading edge to a trailing edge. The partially swept leading edge of the impeller blade is in fluid communication with the inlet duct. The port outlet is defined through the shroud. The partially swept leading edge extends in the streamwise direction at the tip upstream of the port outlet for a distance.

### CROSS REFERENCE TO RELATED APPLICATION

The present application claims benefit of prior filed India Provisional Patent Application No. 202411067577, filed Sep. 6, 2024, which is hereby incorporated by reference herein in its entirety.

### TECHNICAL FIELD

The present disclosure generally relates to gas turbine engines, and more particularly relates to a ported compressor with a partially swept leading edge associated with a gas turbine engine.

### BACKGROUND

Gas turbine engines may be employed to power various devices. For example, a gas turbine engine may be employed to power a mobile platform, such as an aircraft. Generally, gas turbine engines include one or more compressors, which operate to draw air into the gas turbine engine and to raise a pressure of that air. Each of the compressors has one or more airfoils or blades that are rotatable to accomplish this task. In the example of a radial compressor, the radial compressor attains a pressure rise by adding kinetic energy to the air by an impeller, and the kinetic energy is converted to a static pressure rise by a diffuser. The performance of the radial compressor is based on an efficiency of the impeller. Generally, a leading edge of the impeller experiences axial entry of a high flow velocity fluid, which may lead to flow separation along the impeller. The flow separation may result in pressure loss. In the instance of a two-stage compressor, the flow separation along the impeller and pressure losses may impact the downstream impeller, reducing an overall efficiency of the compressors.

Accordingly, it is desirable to provide a ported compressor with a partially swept leading edge for use with a gas turbine engine, which increases an efficiency of the compressor and downstream impeller as applicable. Furthermore, other desirable features and characteristics of the present disclosure will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a compressor section associated with a gas turbine engine includes an inlet duct, a port plenum, and an impeller. The port plenum has a port inlet and a port outlet. The port inlet is in fluid communication with the inlet duct. The impeller includes a hub, a shroud, and an impeller blade. The impeller blade extends for a span that is 0% at the hub and 100% at a tip. The impeller blade has a partially swept leading edge and extends in a streamwise direction from the partially swept leading edge to a trailing edge. The partially swept leading edge of the impeller blade is in fluid communication with the inlet duct. The port outlet is defined through the shroud. The partially swept leading edge extends in the streamwise direction at the tip upstream of the port outlet for a distance.

In another embodiment, a gas turbine engine includes an inlet duct, a port plenum, and an impeller. The inlet duct has a first outlet and a second outlet, where the first outlet is downstream from the second outlet. The port plenum has a port inlet in fluid communication with the second outlet of the inlet duct and has a port outlet that has a dimension. The impeller includes a hub, a shroud, and an impeller blade. The impeller blade extends for a span that is 0% at the hub and 100% at a tip. The shroud is spaced apart from the tip. The impeller blade has a partially swept leading edge and extends in a streamwise direction from the partially swept leading edge to a trailing edge. The partially swept leading edge of the impeller blade is in fluid communication with the first outlet. The port outlet is defined through the shroud downstream of the partially swept leading edge in a direction of fluid flow through the impeller. The partially swept leading edge extends in the streamwise direction at the tip upstream of the port outlet for a distance defined based on the dimension.

In yet another embodiment, a gas turbine engine includes an inlet duct, a port plenum, an impeller, and a second impeller. The duct inlet has a first outlet and a second outlet, where the first outlet is downstream from the second outlet. The port plenum has a port inlet in fluid communication with the second outlet of the inlet duct and has a port outlet having a width. The impeller includes a hub, a shroud, and an impeller blade. The impeller blade extends for a span that is 0% at the hub and 100% at a tip. The shroud is spaced apart from the tip. The impeller blade has a partially swept leading edge and extends in a streamwise direction from the partially swept leading edge to a trailing edge. The partially swept leading edge of the impeller blade is in fluid communication with the first outlet. The port outlet is defined through the shroud downstream of the partially swept leading edge. The partially swept leading edge extends in the streamwise direction at the tip upstream of the port outlet for a distance that is greater than the width. The second impeller is downstream of the impeller.

Furthermore, other desirable features and characteristics of the compressor section and gas turbine engine will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a simplified cross-sectional view of one embodiment of a gas turbine engine, which includes ported compressor with a partially swept leading edge in accordance with the various teachings of the present disclosure;

FIG. 1A is a detailed cross-sectional view of one embodiment of a compressor section that may be used in the gas turbine engine of FIG. 1;

FIG. 2 is a close-up cross-sectional view of the ported compressor with a partially swept leading edge in accordance with various embodiments; and

FIG. 3 is a detail cross-sectional view of the partially swept leading edge of the ported compressor of FIG. 2.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. In addition, those skilled in the art will appreciate that embodiments of the present disclosure may be practiced in conjunction with any type of arrangement that would benefit from a ported compressor with a partially swept leading edge and the use of the ported compressor with the partially swept leading edge associated with a gas turbine engine described herein is merely one exemplary embodiment according to the present disclosure. In addition, while the ported compressor with the partially swept leading edge is described herein as being used with a two-stage compressor for a gas turbine engine onboard a mobile platform, such as a bus, motorcycle, train, motor vehicle, marine vessel, aircraft, rotorcraft and the like, the various teachings of the present disclosure can be used with any number of compressors and a gas turbine engine on a stationary platform. Further, it should be noted that many alternative or additional functional relationships or physical connections may be present in an embodiment of the present disclosure. In addition, while the figures shown herein depict an example with certain arrangements of elements, additional intervening elements, devices, features, or components may be present in an actual embodiment. It should also be understood that the drawings are merely illustrative and may not be drawn to scale.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “about” denotes within 10% to account for manufacturing tolerances. In addition, the term “substantially”denotes within 10% to account for manufacturing tolerances.

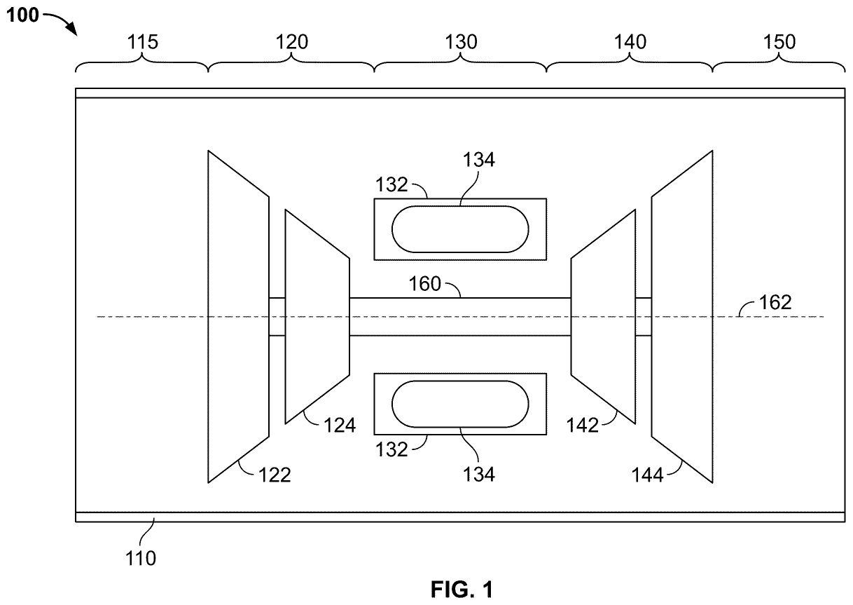

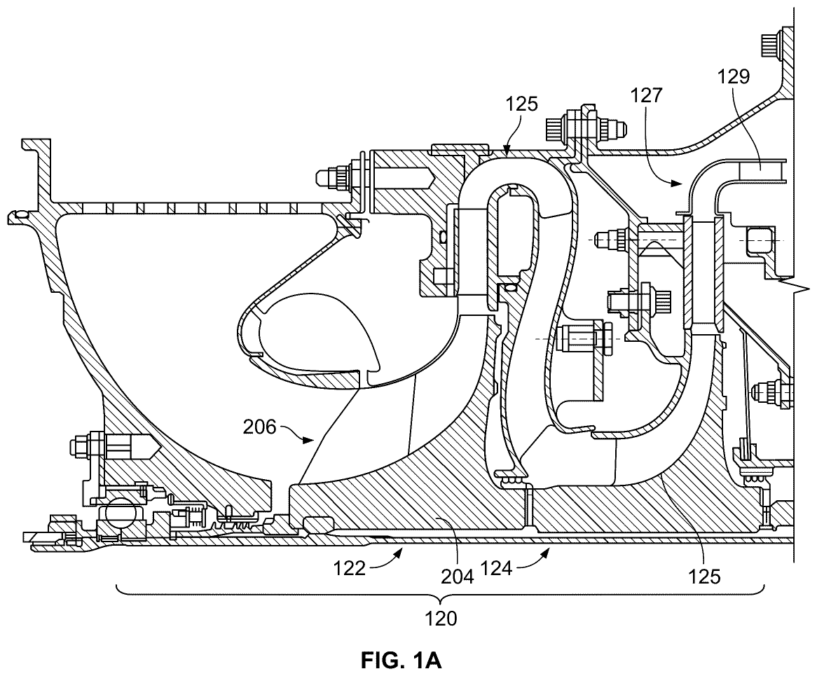

With reference to FIG. 1, a simplified cross-sectional view of one embodiment of a gas turbine engine 100 is depicted. The gas turbine engine 100, which is disposed in an engine housing 110, includes an intake section 115, a compressor section 120, a combustion section 130, a turbine section 140, and an exhaust section 150. The compressor section 120 and turbine section 140 are operably coupled to a shaft assembly 160 for rotation within the housing 102. A fluid (e.g., air) is drawn into the engine housing 110 through the intake section 115 and into the compressor section 120.

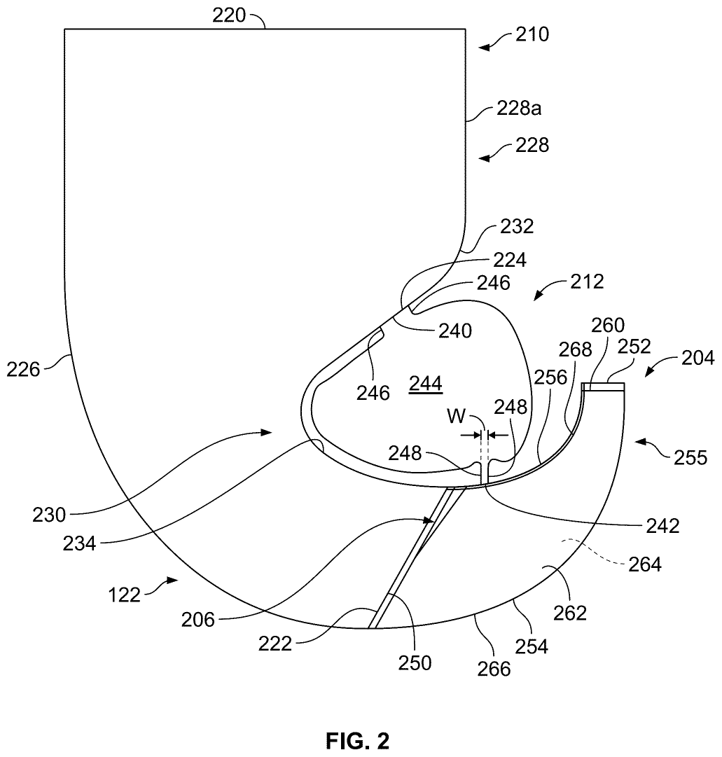

The compressor section 120, an embodiment of which is depicted in more detail in FIG. 1A, is configured as a two-stage compressor section, and includes a ported compressor 122 (first stage) and a downstream compressor 124 (second stage). The ported compressor 122 includes an impeller 204 (see FIGS. 1A and 2) with a partially swept leading edge 206 (see FIGS. 1A and 2). The downstream compressor 114, at least in the depicted embodiment, is a radial compressor, and also includes an impeller 125 (see FIG. 1A). In this example, the downstream compressor impeller 125 has a plurality of impeller blades with a baseline leading edge or without a partially swept leading edge. It should be noted that in other embodiments, the downstream compressor impeller 125 may have a partially swept leading edge, such as the partially swept leading edge 206 described herein. As will be discussed in more detail further below, the partially swept leading edge 206 of the ported compressor impeller 204 improves the efficiency of the compressor section 120. In one example, the partially swept leading edge 206 of the ported compressor impeller 204 improves the overall total efficiency of the compressor section 120 from about 0.4 percent to about 0.8 percent.

As is also depicted in FIG. 1A, it will be appreciated that, at least in some embodiments, a first diffuser 125 is positioned between the ported compressor 122 and the downstream compressor 124, and the ported compressor 122 is spaced apart from the first diffuser 125 by a vaneless gap that is devoid of vanes or airfoils. Additionally, a second diffuser 127 is positioned downstream of the downstream compressor 124, which is spaced apart from the second diffuser 127 by a vaneless gap that is devoid of vanes or airfoils, and is positioned upstream from a deswirler 129. Together, the compressors 122, 124 compress, and thus increase the pressure of, the fluid entering the engine 100 and supply the compressed fluid, via the deswirler 129, into the combustion section 130.

The combustion section 130 includes a combustor air inlet 132 and a combustion chamber 134. The combustor air inlet 132 is in fluid communication with the downstream compressor 124, and it directs the compressed fluid into the combustion chamber 134. In the combustion chamber 134, the compressed fluid is mixed with fuel and is combusted in the combustion chamber 134. Hot exhaust fluids are then directed into the turbine section 140.

The hot exhaust fluids expand through, and rotate, the turbine section 140 prior to being exhausted through the exhaust section 150. The turbine section 140 rotates to drive equipment in the gas turbine engine 110 via rotors or spools concentrically disposed about an axis of rotation 162 within the shaft assembly 160. Specifically, the turbine section 140 may include one or more rotors 142, 144 driven by the expanding hot exhaust fluids to rotate the shaft assembly 160 and drive at least the compressors 122, 124. The shaft assembly 160 drives various other non-depicted components, depending upon whether the gas turbine engine 100 assumes the form of a turbofan, turboprop, turboshaft, turbojet engine, or an auxiliary power unit, to list but a few examples.

With reference now to FIG. 2, a detailed cross-sectional view of a portion of the compressor section 120 including the ported compressor 122 of the gas turbine engine 100 is shown. In one example, the compressor section 120 includes an inlet duct 210, a port plenum 212, and the previously mentioned impeller 204. The downstream compressor 114, and the previously mentioned first diffuser 125, second diffuser 127, and deswirler 129, are also a part of the compressor section 120, but will not be discussed in detail herein. In this example, the inlet duct 210 comprises a portion of a compressor section duct in the intake section 117 of the gas turbine engine 100. Generally, the inlet duct 210 is in fluid communication directs fluid, such as air, into the port plenum 212 and the impeller 204. The inlet duct 210 includes a first, main inlet 220, a first, main outlet 222 and a second, duct outlet 224. The main inlet 220 is in fluid communication with the ambient environment.

In this example, the inlet duct 210 includes a first wall 226 opposite a second wall 228. The main inlet 220 is defined at one end of the first wall 226 and the second wall 228, and the main outlet 222 is defined at an opposite end of the first wall 226 and the second wall 228. The first wall 226 generally curves toward the main outlet 222. The second wall 228 includes a substantially planar portion 228a proximate the main inlet 220, and curves inward, toward the first wall 226 at a bend 230. In this example, the bend 230 is substantially concave, and is defined by a first sloped wall 232 and a second arcuate wall 234. The first sloped wall 232 is upstream from the second arcuate wall 234 in the direction of airflow through the main inlet 220. The duct outlet 224 is defined through the first sloped wall 232 between the planar portion 228a and the second arcuate wall 234. The duct outlet 224 is generally defined to enable a portion of the airflow through the main inlet 220 to flow directly through the duct outlet 224 into the port plenum 212. The second arcuate wall 234 terminates at the main outlet 222. The main outlet 222 is downstream from the main inlet 220, and is in fluid communication with the impeller 204. The main outlet 222 is also downstream from the duct outlet 224.

The port plenum 212 is coupled between the inlet duct 210 and the impeller 204, and is in fluid communication with both the inlet duct 210 and the impeller 204 to define a recirculation flow path. The port plenum 212 includes a port plenum inlet or port inlet 240, a port plenum outlet or port outlet 242 and a plenum 244. The port inlet 240 is in fluid communication or is fluidly coupled to the inlet duct 210 via the duct outlet 224. The port inlet 240 may include a pair of opposed sidewalls 246, which define a duct to fluidly couple the port inlet 240 to the plenum 244.

The port outlet 242 is downstream from the port inlet 240 in a direction of airflow through the inlet duct 210, and is in fluid communication with the plenum 244. The port outlet 242 may include a pair of opposed outlet sidewalls 248 to fluidly couple or interconnect the port outlet 242 with the plenum 244. The port outlet 242 is fluidly coupled to or in fluid communication with the impeller 204. The outlet sidewalls 248 assist in directing the fluid from the plenum 244 onto the impeller 204. As will be discussed, the port outlet 242 is fluidly coupled to the impeller 204 to be downstream from the partially swept leading edge 206. The port outlet 242 is downstream of the main outlet 222 in a direction of airflow through the impeller 204. Generally, the port outlet 242 has a dimension, such as a width or outlet width W. The outlet width W is different and less than an inlet width of the port inlet 240. In one example, the outlet width W is about 0.075 inches to about 0.098 inches.

In one example, the plenum 244 is polygonal in shape. The plenum 244 is defined between the port inlet 240 and the port outlet 242. In one example, the plenum 244 is substantially contained within a space or void defined by the bend 230 of the second wall 228. The port plenum 212 is axisymmetric about the longitudinal axis 140 such that the port outlet 242 is a continuous opening.

The impeller 204 is in fluid communication with the main outlet 222 and the port outlet 242. The impeller 204 has an impeller inlet 250 in fluid communication with the main outlet 222 and an impeller outlet 252 in fluid communication with the first diffuser (FIG. 1). The impeller 204 includes a hub or impeller hub 254, a shroud or impeller shroud 256 and a plurality of impeller blades 258. It should be noted that while the impeller 204 is described herein as including the impeller blades 258, the impeller 204 may also include a plurality of splitter blades, if desired.

The impeller hub 254 is spaced apart from the impeller shroud 256. The impeller hub 254 is substantially annular, and is axisymmetric about the longitudinal axis 140. The impeller hub 254 is coupled to a shaft, such as shaft assembly 160 discussed with regard to FIG. 1. The impeller hub 254 rotates with the shaft, while the impeller shroud 256 is stationary. The impeller hub 254 is composed of a metal or metal alloy, and may be formed by casting, additive manufacturing (direct metal laser sintering (DMLS), etc.), etc. The impeller hub 254 is axially and radially spaced apart from the impeller shroud 256.

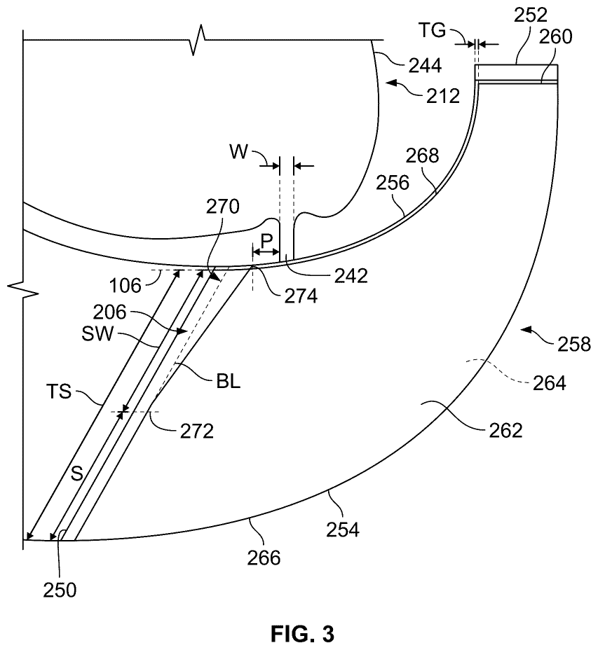

The impeller shroud 256 is positioned opposite the impeller hub 254. The impeller shroud 256 is substantially annular, and is axisymmetric about the longitudinal axis 140. The impeller shroud 256 is composed of a metal or metal alloy, and may be formed by casting, additive manufacturing (DMLS, etc.), etc. The impeller shroud 256 is spaced apart from the impeller blades 258 to define a tip gap TG (see FIG. 3) and to enable the impeller blades 258 to rotate relative to the impeller shroud 256. The impeller shroud 256 may be coupled to a supporting structure associated with the gas turbine engine 100, for example, to maintain the tip gap TG or the spacing of the impeller shroud 256 from the impeller blades 258. In this example, the port outlet 242 is defined through the impeller shroud 256 such that the port plenum 212 is in fluid communication with the impeller blades 258. In this example, the port outlet 242 is defined through the impeller shroud 256 so as to be downstream from the partially swept leading edge 206 in the direction of airflow through the impeller 204.

The impeller blades 258 add kinetic energy to the compressed air received through the impeller inlet 250. The impeller blades 258 are each composed of a metal or metal alloy, and may be formed by casting, additive manufacturing (DMLS, etc.), etc. The impeller blades 258 are generally integrally formed with the impeller hub 254; however, the impeller blades 258 may be discretely formed and coupled to the impeller hub 254. The impeller 204 has the plurality of the impeller blades 258, which are spaced apart in an annular array about a circumference of the impeller hub 254. Each of the impeller blades 258 includes the partially swept leading edge 206 and an opposite, downstream trailing edge 260. The partially swept leading edge 206 is in fluid communication with the impeller inlet 250, but is downstream from and spaced apart from the impeller inlet 250. The trailing edge 260 is downstream from the partially swept leading edge 206, and is upstream from and spaced apart from the impeller outlet 252. In this example, the trailing edge 260 extends along an axis, which is substantially parallel to the longitudinal axis 140 of the gas turbine engine 100 (FIG. 1).

Each of the impeller blades 258 has a pressure side 262 and an opposed suction side 264. The pressure side 262 and the suction side 264 extend from the partially swept leading edge 206 to the trailing edge 260 and from a root 266 to a tip 268 of the respective impeller blade 258. The tip 268 is proximate the impeller shroud 256, and the root 266 is coupled to the impeller hub 254. With reference to FIG. 3, each of the impeller blades 258 has a span S, which is 0% at the root 266 and 100% at the tip 268. Thus, each of the impeller blades 258 generally extend in a spanwise direction from the root 266 (at 0% span) to the tip 268 (at 100% span). Stated another way, each of the impeller blades 258 have a span TS, which is 0% at the root 266 and 100% at the tip 268. Each of the impeller blades 258 also has a blade height in the spanwise direction.

In addition, the pressure side 262 and the suction side 264 are opposed in a thickness direction normal to a respective mean camber line that extends from partially swept leading edge 206 to the trailing edge 260 for a particular location along the span TS (0% to 100% span) or spanwise location. The mean camber line of each of the impeller blades 258 at a particular spanwise location is a line joining the partially swept leading edge 206 and the trailing edge 260, which is equidistant from the pressure side 262 to the suction side 264. Thus, along the span TS of the impeller blade 258 from 0% at the root 266 to 100% at the tip 268, each spanwise location has a respective mean camber line, which connects the partially swept leading edge 206 and the trailing edge 260 and is equidistant from the pressure side 262 and the suction side 264. Generally, the mean camber line is 0% at the partially swept leading edge 206, and is 100% at the trailing edge 260. Stated another way, for a particular location along the span TS or spanwise location of the respective impeller blade 258, the mean camber line extends in a streamwise direction Ds from 0% at the partially swept leading edge 206 to 100% at the trailing edge 260, equidistant between the pressure side 262 and the suction side 264. Generally, the streamwise direction Ds is a direction of fluid flow through the impeller 204, which is from the partially swept leading edge 206 to the trailing edge 260 of the impeller 204. In one example, each of the impeller blades 258 is somewhat asymmetrical and cambered along the respective mean camber line. The pressure side 262 has a contoured, generally convex surface geometry, which gently bends or curves in three dimensions. The suction side 264 has a contoured, generally concave surface geometry, which likewise bends or curves in three dimensions. In other embodiments, the impeller blades 258 may not be cambered and may be either symmetrical or asymmetrical. The pressure side 262 and the suction side 264 also extend in a chordwise direction along a chord line. The chord line has a chord length CH1, which is a numerical value for a distance along a straight line that connects the partially swept leading edge 206 to the trailing edge 260 at the particular spanwise location of the impeller blades 258.

As discussed, each of the impeller blades 258 has the partially swept leading edge 206. Generally, the partially swept leading edge 206 of each of the impeller blades 258 is defined so as to be spaced apart from the impeller hub 254, and to extend toward the trailing edge 260 in the streamwise direction Ds. In one example, the partially swept leading edge 206 includes a sweep 270 defined at a predetermined partial span S from the impeller hub 254. Stated another way, the partially swept leading edge 206 is unswept along the leading edge for the partial span S, and the sweep 270 (or partial sweep of the leading edge) is defined beyond the span S such that the sweep 270 extends from the partial span S over a sweep span SW and ends at the tip 268. The sum of the partial span S and the sweep span SW is the total span TS, or 100%. The sweep span SW is generally 100% minus the partial span S. In one example, the partial span S is about 25% to about 95% and the sweep span SW is about 75% to about 5%.

The sweep 270 is a cutback or removal of a baseline leading edge BL of the impeller blade 258 in the streamwise direction over the sweep span SW to form the partially swept leading edge 206. The baseline leading edge BL is devoid of the partial sweep. In one example, the sweep 270 is defined in the streamwise direction substantially monotonically such that a positive slope is defined from a first span location or sweep start span location 272 to a sweep end span location 274 over the sweep span SW. The sweep start span location 272 is at the start of the sweep span SW and the sweep end span location 274 is at the tip 268. Generally, the sweep 270 is defined so that the impeller blade 258 extends for a distance P at the tip 268 upstream of the port outlet 242 in a direction of airflow through the impeller 204. Stated another way, the distance P is defined between the partially swept leading edge 206 at the tip 268 and the port outlet 242. In one example, the distance P is about two to about three times the outlet width W of the port outlet 242. Thus, the distance P is defined based on a dimension associated with the port outlet 242, which in this example is the outlet width W. The distance P is greater than the dimension associated with the port outlet 242.

The partially swept leading edge 206 results in the removal of material or a reduction in blade height of the impeller blade 258 in the streamwise direction from the sweep start span location 272 to the sweep end span location 274 at the tip 268 so that the tip 268 of the impeller blade 258 at the partially swept leading edge 206 extends for the distance P to the port outlet 242. Generally, the sweep 270 results in about 45% to about 50% of the chord line at the tip 268 between the baseline leading edge BL and the port outlet 242 being removed, cutback or clipped. The tip 268 of the impeller blade 258 extends in the streamwise direction for at least 50% of a distance defined between the baseline leading edge BL and the port outlet 242 along the mean camber line of the tip 268.

In one example, the impeller 204 is formed with the impeller blades 258 including the partially swept leading edge 206 in the annular array about the impeller hub 254. The impeller hub 254 is coupled to the shaft, such as the shaft assembly 160 discussed with regard to FIG. 1. The impeller shroud 256 is coupled to the gas turbine engine 100 so as to be opposite the impeller hub 254 and spaced apart from the impeller blades 258 by the tip gap TG. The first diffuser is coupled to the gas turbine engine 100 such that the impeller 204 is circumscribed by the first diffuser and the vaneless gap is defined between the first diffuser and the impeller 204. With the compressor section duct formed, the compressor section duct is coupled to the gas turbine engine 100 such that the main outlet 222 of the inlet duct 210 is in fluid communication with the partially swept leading edge 206. With the port plenum 212 formed, the port plenum 212 is coupled to the inlet duct 210 such that the port inlet 240 is fluidly coupled to the duct outlet 224 defined in the second wall 228 of the inlet duct 210, and the port outlet 242 is fluidly coupled to or defined through the impeller shroud 256 so as to be in fluid communication with the impeller blade 258 downstream of the partially swept leading edge 206.

During operation of the gas turbine engine 100, the air from the ambient environment is drawn into the main inlet 220, and flows through the inlet duct 210 to exit onto the partially swept leading edge 206 at the main outlet 222. The air also flows through the inlet duct 210 into the port plenum 212, and the air exits the port plenum 212 onto the tip 268 downstream of the partially swept leading edge 206 via the port outlet 242. The impeller blades 258 of the impeller 204, which may be driven by the tie-shaft 106 (FIG. 1), impart kinetic energy into the compressed air. The air exits the impeller outlet 252 and flows into the first diffuser. The first diffuser converts the kinetic energy imparted by the impeller 204 into a static pressure rise. From the first diffuser, the air flows through the cross-over duct to the downstream compressor 124. From the downstream compressor 124, the air flows through the second diffuser and from the second diffuser to the deswirler. From the deswirler, the air enters the combustion chamber 134 where it is mixed with fuel and combusted. The combusted air is then directed into the turbine section 140.

By providing the impeller 204 of the first stage compressor 122 or the compressor 122 directly downstream from the intake section 115 of the gas turbine engine 100, the overall total efficiency of the compressor section 120 may be increased from about 0.4 percent to about 0.8 percent. In addition, the impeller blades 258 with the partially swept leading edge 206 improve overall stall margin of the compressor section 108 from about 1 percent to about 7 percent. The impeller blades 258 with the partially swept leading edge 206 improve the overall total pressure ratio of the compressor 202 up to about 1 percent, and improve choke flow capacity of the compressor 122 from about 1 percent to about 2 percent. The diffusion losses associated with the first stage or the compressor 122 are also reduced.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A compressor section associated with a gas turbine engine, comprising:
an inlet duct;
a port plenum having a port inlet in fluid communication with the inlet duct and a port outlet; and
an impeller including a hub, a shroud, and an impeller blade, the impeller blade extending for a span that is 0% at the hub and 100% at a tip, the impeller blade having a partially swept leading edge and extending in a streamwise direction from the partially swept leading edge to a trailing edge, the partially swept leading edge of the impeller blade in fluid communication with the inlet duct, the port outlet defined through the shroud, and the partially swept leading edge extends in the streamwise direction at the tip upstream of the port outlet for a distance, wherein the distance is defined based on a dimension associated with the port outlet and is greater than the dimension associated with the port outlet.

2. (canceled)

3. The compressor section of claim 1, wherein the dimension is a width of the port outlet.

4. The compressor section of claim 3, wherein the distance is two to three times the width.

5. The compressor section of claim 1, wherein the partially swept leading edge extends over a portion of the span and ends at the tip.

6. The compressor section of claim 5, wherein the partially swept leading edge extends over at least 25% of the span.

7. The compressor section of claim 1, wherein the inlet duct includes a first outlet and a second outlet, the first outlet is in fluid communication with the partially swept leading edge and is downstream from the second outlet, and the second outlet is in fluid communication with the port plenum.

8. The compressor section of claim 1, wherein the partially swept leading edge extends along a positive slope from a first span location to the tip.

9. The compressor section of claim 1, further comprising a second impeller downstream of the impeller.

10. A gas turbine engine, comprising:
an inlet duct having a first outlet and a second outlet, the first outlet downstream from the second outlet;
a port plenum having a port inlet in fluid communication with the second outlet of the inlet duct and a port outlet having a dimension; and
an impeller including a hub, a shroud, and an impeller blade, the impeller blade extending for a span that is 0% at the hub and 100% at a tip, the shroud spaced apart from the tip, the impeller blade having a partially swept leading edge and extending in a streamwise direction from the partially swept leading edge to a trailing edge, the partially swept leading edge of the impeller blade in fluid communication with the first outlet, the port outlet defined through the shroud downstream of the partially swept leading edge in a direction of fluid flow through the impeller, and the partially swept leading edge extends in the streamwise direction at the tip upstream of the port outlet for a distance that is greater than the dimension.

11. The gas turbine engine of claim 10, wherein the dimension is a width of the port outlet.

12. The gas turbine engine of claim 11, wherein the distance is about two to three times the width.

13. The gas turbine engine of claim 10, wherein the partially swept leading edge extends over a portion of the span and ends at the tip.

14. The gas turbine engine of claim 13, wherein the partially swept leading edge extends over at least 25% of the span.

15. The gas turbine engine of claim 10, wherein the partially swept leading edge extends along a positive slope from a first span location to the tip.

16. The gas turbine engine of claim 10, further comprising a second impeller downstream of the impeller.

17. A gas turbine engine, comprising:
an inlet duct having a first outlet and a second outlet, the first outlet downstream from the second outlet;
a port plenum having a port inlet in fluid communication with the second outlet of the inlet duct and a port outlet having a width;
an impeller including a hub, a shroud, and an impeller blade, the impeller blade extending for a span that is 0% at the hub and 100% at a tip, the shroud spaced apart from the tip, the impeller blade having a partially swept leading edge and extending in a streamwise direction from the partially swept leading edge to a trailing edge, the partially swept leading edge of the impeller blade in fluid communication with the first outlet, the port outlet defined through the shroud downstream of the partially swept leading edge, and the partially swept leading edge extends in the streamwise direction at the tip upstream of the port outlet for a distance that is greater than the width; and
a second impeller downstream of the impeller.

18. The gas turbine engine of claim 17, wherein the partially swept leading edge extends over a portion of the span and ends at the tip.

19. The gas turbine engine of claim 18, wherein the partially swept leading edge extends over at least 25% of the span.

20. The gas turbine engine of claim 17, wherein the partially swept leading edge extends along a positive slope from a first span location to the tip.
